(19) United States
(12) Patent Application Publication
(10) Pub. No.: US 2023/0010580 A1
(43) Pub. Date: Jan. 12, 2023

(54) CROSS-FIELD INDUCTION HEATING DEVICE

(71) Applicant: ABP Induction Systems GmbH, Dortmund (DE)

(72) Inventors: Achim Thus, Rheinberg (DE); Andrejs Umbrasko, Holzwickede (DE)

(73) Assignee: ABP Induction Systems GmbH, Dortmund (DE)

(21) Appl. No.: 17/784,754

(22) PCT Filed: Nov. 27, 2020
(86) PCT No.: PCT/DE2020/000292

§ 371 Date: Jun. 13, 2022

(30) Foreign Application Priority Data
Dec. 13, 2019 (DE) 10 2019 008 622.8

(51) Int. Cl. H05B 6/10; H05B 6/36; H05B 6/14

(52) U.S. Cl. CPC H05B 6/101; H05B 6/362; H05B 6/145

(57) ABSTRACT

A transverse field induction heating apparatus for the inductive heating of sheet metal in a rolling mill includes an upper inductor and a lower inductor. The upper inductor includes two adjacently positioned upper partial induction loops which are series-connected and fed an electrical current in opposite directions. The lower inductor includes two adjacently positioned lower partial induction loops which are series-connected and fed an electrical current in opposite directions. The electrical current in both partial induction loops is oriented in an opposing direction. Each of the upper and lower partial induction loop is structured to be moved individually perpendicular to a sheet axis and includes a rounded head positioned adjacent to each other such that the rounded head is shaped as a hammer head.

### CROSS REFERENCE TO RELATED INVENTION

This application is a national stage application pursuant to 35 U.S.C. § 371 of In-ternational Application No. PCT/DE2020/000292, filed on Nov. 27, 2020, which claims priority to, and benefit of, German Patent Application No. 10 2019 008 622.8, filed Dec. 13, 2019, the entire contents of which are hereby incorporated by reference.

### TECHNOLOGICAL FIELD

The present disclosure relates to a transverse field induction heating apparatus for the inductive heating of sheet metal in a rolling mill having an upper inductor and a lower inductor, between which the metal sheet to be heated is arranged.

### BACKGROUND

Transverse field induction heating apparatuses of this kind are known. For example, a transverse field induction heating apparatus is described in CN 104508154 B in which two inductors are arranged above and below a metal sheet in order to heat the metal sheet. Both inductors have a conducting part (feed part) and a conveying part which are arranged on the same side of the sheet to be heated. Moreover, each inductor has a curved head, each of which is assigned an edge of the sheet to be heated and is arranged on different sides of the sheet metal. The fact that, in this arrangement, all the parts are arranged on one side of the sheet to be heated yields a particularly good use of space of the available area in a rolling line.

Another transverse field induction heating apparatus is described in EP 2 624 974 B1. The heating apparatus has inductors which are provided between two adjacently arranged rolling stands. The inductors each include a conductor loop above and below a sheet to be heated, and each consists of a C-shaped induction bracket that is open on the rolling line operating side and is closed on the drive side at least by the inductor feeds. An inductor pair with a total of two inductors is arranged adjacently in the belt running direction. The two inductor pairs can each move opposite each other perpendicular to the sheet running direction depending on the width of the sheet so that overall, a symmetrical heating effect of the sheet is achieved. In so doing, the inductor feeds are moved together with each of the connected inductors perpendicular to the sheet running direction.

These known transverse field induction heating apparatuses generally function well to achieve even inductive heating of the metal sheet. However, sometimes problems can result in terms of overheating the sheet edges.

### BRIEF SUMMARY OF THE INVENTION

The object of the present invention is to provide a transverse field induction heating apparatus of the above-described type that allows sheet edge heating to be controlled particularly well.

This object is achieved according to the invention with a transverse field induction heating apparatus of the indicated type such that each inductor is divided into two adjacently arranged partial induction loops which are series-connected and fed in opposite directions such that the divided, fed, equal current in both partial induction coils is oriented in opposite directions.

By dividing each inductor into two adjacently arranged partial induction loops according to the invention, a particularly high surface power density is achieved with low edge overheating. Given the division into two conductor loops that are fed in opposite directions and arranged adjacent to each other, the power input into the sheet to be heated is much less in the region between the conductor loops in comparison to the region below the conductor loops so that less heating results. This prevents the sheet edge from overheating with maximum surface power density.

Since the divided current in both loops is oriented in opposite directions, the resulting magnetic fields are compensated in the head region of the inductor. This prevents a circular current from being induced over the non-insulated drive rollers for the sheet.

With the two partial coils fed in the opposite direction, the resulting magnetic flux that runs through a conductor loop which symmetrically includes the two partial coils zeros out. No electrical voltage is therefore induced in the conductor loop so that the current in the loop is also zero.

In an embodiment, the two adjacently arranged partial induction loops are arranged in a coil housing. They are in particular arranged within a shielding cap in order to dampen the resulting stray field.

Each partial induction loop can be moved individually perpendicular to the sheet axis. This can support the threading of the sheet head. If there is a sheet jam, the coils can be opened to remove the excess material.

In an embodiment, the two partial induction loops are arranged between two drive rollers of the sheet to be heated. If a conductor loop is formed by the sheet and the two grounded drive rollers for the sheet, this prevents arcing between the sheet and drive roller, and also avoids current over the bearing points.

With the solution according to the invention, suppression of parasitic circular currents is furthermore achieved.

In a particularly preferred embodiment, both partial induction loops have rounded heads arranged adjacent to each other. In the head region, each partial induction loop is preferably designed like a hammer head. It has been revealed that the edge heating of the sheet can be controlled particularly well with such hammer heads. The hammer head geometry of the inductor head is therefore revealed to be superior than the known lamp shape geometry.

In general, dividing an inductor into two opposite loops yields heating across a shorter path, wherein significantly less heating is achieved in particular at the edge in the foot region of the sheet.

With the embodiment according to the invention, each partial induction loop preferably has supply and return conductors that run parallel to each other preferably in their foot region. The partial induction coils, in particular in a standard position, extend with their hammer head beyond one sheet edge, and extend with their supply and return conductors beyond the other sheet edge. As already mentioned, this prevents the edges from overheating and suppresses parasitic circular currents, and achieves a higher surface power density with less edge overheating.

### BRIEF DESCRIPTION OF THE DRAWINGS

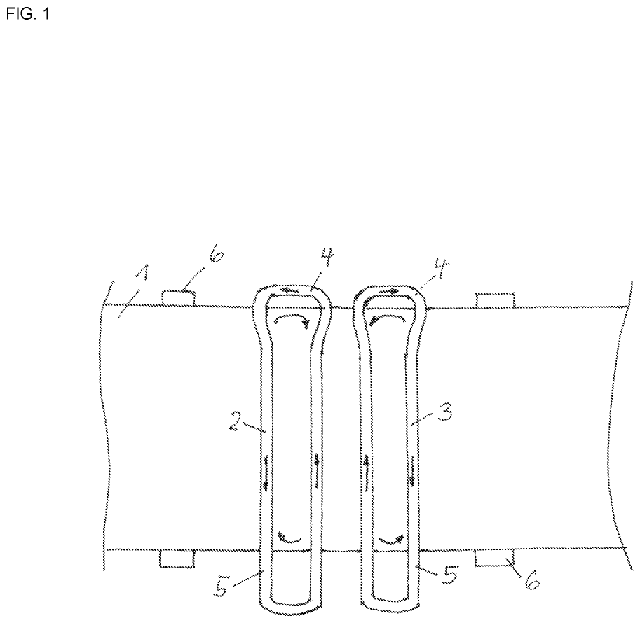

The invention will be explained in detail below with reference to an exemplary embodiment in conjunction with FIG. 1, which schematically depicts a plan view of part of a transverse field induction heating apparatus.

### DETAILED DESCRIPTION OF THE INVENTION

With the transverse field induction heating apparatus described here, only one inductor divided into two partial induction loops 2, 3 is shown above a sheet 1 to be heated of a rolling line, while the associated inductor below the sheet and corresponding feed apparatuses, conveying apparatuses, etc. of the induction heating apparatus are not shown. What is essential is that the inductor shown here is divided into two adjacently arranged partial induction loops 2, 3 which are series-connected and fed in opposite directions so that the divided, fed, equal current in both partial induction coils 2, 3 is oriented in opposite directions, as indicated by corresponding arrows in the partial induction loops 2, 3. The direction of the current induced in sheet 1 is also indicated by arrows.

The two adjacently arranged partial induction loops 2, 3 each comprise a head region 4 and a foot region 5. The head region is structured or shaped like a hammer head, whereas the foot region 5 has a supply and return conductor that run parallel to each other. Each head region and foot region extend in the standard position shown here beyond an edge of the metal sheet to be heated.

Both partial induction loops 2, 3 can be moved independent of each other relative to the axis of the metal sheet, wherein their position can be correspondingly controlled in order to achieve very even heating of the metal sheet.

Overall, the transverse field induction heating apparatus is arranged between two adjacent drive rollers 6 of the metal sheet.

The two partial induction loops 2, 3 are in a common coil housing (not shown) and are series-connected and arranged within a shielding cap (not shown) to dampen the resulting stray field.

Given the division into two conductor loops that are fed in opposite directions and arranged adjacent to each other, the power input into the metal sheet 1 is heated much less in the region between the conductor loops. This prevents the sheet edge from overheating with maximum surface power density. Since the divided current in both loops is oriented in opposite directions, the resulting magnetic fields are compensated in the head region of the inductor. This prevents a circular current from being induced over the non-insulated drive rollers 6.

1-9. (canceled)

10. A transverse field induction heating apparatus for the inductive heating of sheet metal in a rolling mill, comprising:
an upper inductor comprising two adjacently positioned upper partial induction loops which are series-connected and fed an electrical current in opposite directions; and
a lower inductor comprising two adjacently positioned lower partial induction loops which are series-connected and fed an electrical current in opposite directions,
wherein the electrical current in both partial induction loops is oriented in an opposing direction,
wherein each upper and lower partial induction loop is configured to be moved individually perpendicular to a sheet axis,
wherein each upper and lower partial induction loop comprises a rounded head positioned adjacent to each other, and wherein the rounded head is shaped as a hammer head.

11. The transverse field induction heating apparatus according to claim 10, wherein the two adjacently positioned upper and lower partial induction loops are positioned in a single coil housing.

12. The transverse field induction heating apparatus according to claim 10, wherein the two adjacently positioned upper and lower partial induction loops are positioned between two drive rollers of the sheet metal to be heated.

13. The transverse field induction heating apparatus according to claim 10, wherein the two adjacently positioned upper and lower partial induction loops are positioned within a shielding cap.

14. The transverse field induction heating apparatus according to claim 10, wherein each of the two adjacently positioned upper and lower partial induction loops comprise supply and return conductors that run parallel to each other in their foot region.

15. The transverse field induction heating apparatus according to claim 14, wherein when the two adjacently positioned upper and lower partial induction loops are positioned in a standard position, the rounded head of each upper and lower partial induction loop is configured to extend beyond one sheet edge, and the supply and the return conductors are configured to extend beyond an opposing sheet edge.
